(19) United States
(12) Patent Application Publication
(10) Pub. No.: US 2010/0161878 A1
(43) Pub. Date: Jun. 24, 2010

(54) METHOD OF UNLOCKING PORTABLE MEMORY DEVICE

(75) Inventor: Eddie Chung Wa Chang, Hong Kong (CN)

Correspondence Address: LEYDIG VOIT & MAYER, LTD, 700 THIRTEENTH ST. NW, SUITE 300, WASHINGTON, DC, 20005-3960, US

(73) Assignee: GIGAFLASH LIMITED, Hong Kong (CN)

(21) Appl. No.: 12/337,844

(22) Filed: Dec. 18, 2008

(51) Int. Cl. G06F 12/14; G06F 12/00; G06F 12/02

(52) U.S. Cl. 711/103; 711/163; 711/115; 711/E12.001; 711/E12.008; 711/E12.098

(57) ABSTRACT

A method of unlocking usable memory space of a portable memory device, such as a flash drive, includes connecting the portable memory device to a network access device, such as a computer. The network access device executes a control program and accesses a website through the network access device by execution of the control program. A specific task is executed at the website, which sends an unlocking code upon completion of the task. The usable memory space of the portable memory device is unlocked in response to receiving the unlocking code at the network access device.

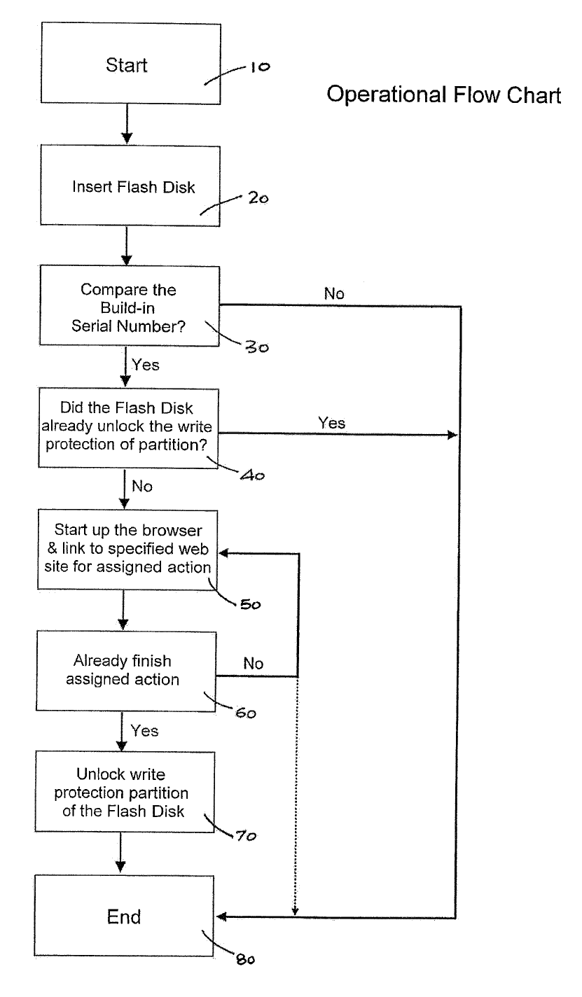

The present invention relates to a method of unlocking a portable memory device, such as a USB flash drive or flash memory card, via an electronic network and in particular the Internet.

### BACKGROUND OF THE INVENTION

Portable memory devices such as USB flash drives and flash memory cards are often provided with a small slide button to lock/unlock the flash memory. Such a mechanical means is inflexible and adds to the cost.

The invention seeks to mitigate or at least alleviate such shortcoming by introducing a new method of unlocking a portable memory device.

### SUMMARY OF THE INVENTION

According to the invention, there is provided a method of unlocking a portable memory device, comprising:
supplying a portable memory device whose usable memory space is initially locked against use;
connecting the portable memory device to an network access device;
executing a control program by the network access device;
accessing a specific website using the network access device through execution of the control program;
performing a specific task at the website;
receiving an unlocking code from the website upon completion of the task; and
unlocking the usable memory space of the portable memory device using the unlocking code through execution of the control program.

Preferably, the method includes write protecting the portable memory device initially to lock its usable memory space against use.

It is preferred that the method includes dividing memory space of the portable memory device into a first partition for storing the control program and a second partition as the usable memory space initially locked against use, and storing the control program in the first partition.

Preferably, the method includes authenticating through execution of the control program the portable memory device by reference to a device code stored in the portable memory device, and terminating execution of the control program if said authenticating fails without accessing the website.

It is preferred that the method includes checking through execution of the control program whether the usable the usable memory space of the portable memory device has been unlocked, and terminating execution of the control program if this is the case without accessing the website.

Preferably, the method includes hosting a said website.

In a preferred embodiment, the method includes altering a register code in a flash controller of the portable memory device to unlock the portable memory device.

### BRIEF DESCRIPTION OF DRAWING

The invention will now be more particularly described, by way of example only, with reference to the accompanying drawing, which is an operational flow chart illustrating various steps of an embodiment of a method of unlocking a portable memory device in accordance with the invention.

### DETAILED DESCRIPTION OF PREFERRED EMBODIMENT

Referring to the drawing, there is illustrated a method of unlocking a portable memory device embodying the invention, which portable memory device may be a USB flash drive for example (or a flash memory card such as an SD or CF card). The method is primarily concerned with unlocking of the USB flash drive, and in particular its memory storage space, through the Internet using a website.

The storage space of the USB flash drive is preferably divided into two partitions, i.e. a first partition of a relatively small size (e.g. a few KB to several MB) and a second partition of a relatively large size (e.g. around 1 GB to 32 GB). Whilst the large second partition represents the main storage area or space for digital content, etc., the small first partition is provided for containing a dedicated control program for primarily monitoring and/or managing availability of the main storage space.

The first partition may be configured as a virtual CD-ROM or the like such that the control program therein is autorun upon the USB flash drive being (first) plugged into a PC or notebook computer.

The read/write protection status or setting of flash memory is controlled by a number of register codes in the Flash Controller (IC) of the USB flash drive (or flash memory card, etc.) These register codes may be controlled or altered by a program or software, but this is rarely done for the purpose concerned.

The second partition is locked at the outset, with the default factory setting of the USB flash drive being in write protection mode by adjusting the register codes inside the Flash Controller such that the main storage space cannot be written with data (or in read/write protection mode such that both read and write actions are prohibited).

A device ID or code for device authentication, such as a serial number, may be embedded in the first partition (or in the second partition that is readable initially).

A user is barred from using and in particular writing data into the main storage space when the USB flash drive is first plugged into a computer. To unlock the storage space, the user is required is to accomplish a certain assigned action or task through accessing a hosting website via the Internet. This is initiated by the control program pre-installed in the USB flash drive, which will be run by the computer automatically upon plugging in of the USB flash drive.

In this regard, the USB flash drive may be supplied with printed instructions that outline the procedures and in particular the action or task that is required to accomplish online to unlock the storage space. As an example, the control program will automatically pop-up an Internet browser and guide the user to register a membership or VIP through a website hosted by a web server of a company supplying the USB flash drive.

Upon successful completion of the task, the website server will return an unlocking code (or a cookie or file or the like) to the user's computer. The control program will then check the validity of the received code. If the code is approved by the control program, the storage space of the USB flash drive will immediately be unlocked, for example by disabling the write protection, and hence become available for full use by the user.

Once the main storage space of the USB flash drive is unlocked, write protection is disabled and a flag or register (general purpose, programmable) in the USB flash drive controller may be set to indicate the status of the storage space. This flag or register may be used to terminate or stop the control program every time the USB flash drive is used again with the same or any other computer apparatus. Thus, it will only be necessary to unlock the storage space once. The received unlocking code may be stored in the USB flash drive upon approval, or simply deleted as the storage space has been unlocked. The unlocking procedures with related communication are performed via the Internet.

The control program or relevant software for running the unlocking procedures may be built into a third party

software such that the third party software can obtain an unlocking code via the Internet. This method is generally the same as the unlocking procedures of the subject invention, but the unlocking software is stored in a different partition or an external location (i.e. outside the portable memory device).

The drawing is an operational flow chart that illustrates various steps of the subject unlocking method.

At start [step 10], upon plugging of the USB flash drive into the computer [step 20], the control program in the first partition autoruns and looks for and compares the embedded serial number [step 30] to ensure that the USB flash drive is a device from a proprietary source. If the serial number is absent or incorrect, the control program will immediately terminate or end [step 80]. Upon authentication of the USB flash drive, the control program will then check whether the second partition (i.e. the main storage space) is locked or has been unlocked [step 40], while in the OS background keeping track of arrival of an unlocking cookie or code from the Internet.

If the second partition is locked, the control program will start up an Internet browser in the system to direct the user to the specific website (operating the subject memory unlocking scheme) for performing an assigned action [step 50]. On the other hand, if the USB flash drive has previously been unlocked, the control program will immediately exit [step 80].

As to the assigned action, the user may be guided to, for example, follow certain on-screen instructions to register a membership or VIP using the website. The relevant hosting web server will issue an unlocking cookie or code to the user's computer upon successful completion of the assigned action [step 60], otherwise the request for action (e.g. user registration) will be maintained.

The control program will keep monitoring feedback from the website (i.e. an unlocking cookie/code) to make sure that the user has accomplished the assigned task properly. In the affirmative, the control program will unlock the write-protected main storage area of the USB flash drive [step 70].

In a specific embodiment, the unlocking cookie contains a file and an unlocking code in the file. The control program will first check the name of the file when the cookie arrives. If the name is right, it will go on to compare the unlocking code in the cookie file with the unlocking code preset in the program. If the two codes match, the control program will then adjust the register codes in the Flash Controller of the USB flash drive to unlock its main storage space. Upon being unlocked, the USB flash drive can freely be used for data read and write, just like a normal drive.

The described method provides for online unlocking of USB flash drives (or flash memory cards or in general portable memory devices) using an embedded software (i.e. the control program described above) through communication with a dedicated website.

The hosting website determines the action(s) for users to perform, and in particular entering data, before it issues an unlocking code. This creates an online platform on which a large variety of services and products that involve or require collection and/or update of data and information can be provided. Promotional information can be posted onto the website or delivered to users.

The hosting company would be running a business using the website as an online platform, and it supplies the relevant USB drives to users who would then become its customers. A live example in practice is described below.

Recruitment agencies need to keep updating their database so that the CVs (curriculum vitas) of job seekers at the database stay current. It is necessary for the recruitment agencies to encourage applicants/candidates to register and/or update their CVs at the website online promptly or constantly as required. Traditionally, their promotion methods would be through online advertising banners, emails and magazines, etc. The USB drives (or flash memory cards or the like) according to the present invention provide a whole new opportunity for them to encourage and drive registration of job seekers effectively. Both the agencies and the registrants will benefit from the scheme. The USB drives may be pre-loaded with digital contents such as music, videos, games and software for unlocking upon registration/update to enhance attraction to customers.

This concept may also be applied to companies doing e-business or online game platforms, etc.

The subject invention allows software unlocking of portable memory devices. As the unlocking program is able to carry out cross-platform operations, it can communicate with third-party software or programs. The software is also able to communicate with website platforms or programming, thereby enabling remote unlocking of portable memory devices via the Internet or any other similar electronic networks.

The invention has been given by way of example only, and various other modifications of and/or alterations to the described embodiment may be made by persons skilled in the art without departing from the scope of the invention as specified in the appended claims.

1. A method of unlocking a portable memory device, comprising:
supplying a portable memory device having usable memory space that is initially locked against use;
connecting the portable memory device to a network access device;
executing, by the network access device, a control program;
accessing a specific website, using the network access device, execution of the control program;
performing a specific task at the website;
receiving an unlocking code from the website upon completion of the specific task; and
unlocking the usable memory space of the portable memory devices using the unlocking code, by the execution of the control program.

2. The method of unlocking a portable memory device as claimed in claim 1, including write protecting the portable memory device initially to lock the usable memory space against use.

3. The method of unlocking a portable memory device as claimed in claim 1, including dividing memory space of the portable memory device into a first partition for storing the control program and a second partition as the usable memory space initially locked against use, and storing the control program in the first partition.

4. The method of unlocking a portable memory device as claimed in claim 1, including
authenticating, through the execution of the control program, the portable memory device by reference to a device code stored in the portable memory device, and
terminating the execution of the control program if the authenticating fails, without accessing the website.

5. The method of unlocking a portable memory device as claimed in claim 1, including
checking, through the execution of the control program, whether the usable memory space of the portable memory device has been unlocked, and
terminating the execution of the control program if the usable memory space of the portable memory device has already been unlocked, without accessing the website.

6. The method of unlocking a portable memory device as claimed in claim 1, including hosting the website.

7. The method of unlocking a portable memory device as claimed in claim 1, including altering a register code in a flash controller of the usable memory space of the portable memory device to unlock the portable memory device.

8. The method of unlocking a portable memory device as claimed in claim 2, including dividing memory space of the portable memory device into a first partition for storing the control program and a second partition as the usable memory space initially locked against use, and storing the control program in the first partition.

9. The method of unlocking a portable memory device as claimed in claim 2, including
authenticating, through the execution of the control program, the portable memory device by reference to a device code stored in the portable memory device, and
terminating the execution of the control program if the authenticating fails, without accessing the website.

10. The method of unlocking a portable memory device as claimed in claim 3, including
authenticating, through the execution of the control program, the portable memory device by reference to a device code stored in the portable memory device, and
terminating the execution of the control program if the authenticating fails, without accessing the website.

11. The method of unlocking a portable memory device as claimed in claim 2, including
checking, through the execution of the control program, whether the usable memory space of the portable memory device has been unlocked, and
terminating the execution of the control program if the usable memory space of the portable memory device has already been unlocked, without accessing the website.

12. The method of unlocking a portable memory device as claimed in claim 3, including
checking, through the execution of the control program, whether the usable memory space of the portable memory device has been unlocked, and
terminating the execution of the control program if the usable memory space of the portable memory device has already been unlocked, without accessing the website.

13. The method of unlocking a portable memory device as claimed in claim 4, including
checking, through the execution of the control program, whether the usable memory space of the portable memory device has been unlocked, and
terminating the execution of the control program if the usable memory space of the portable memory device has already been unlocked, without accessing the website.

14. The method of unlocking a portable memory device as claimed in claim 2, including hosting the website.

15. The method of unlocking a portable memory device as claimed in claim 3, including hosting the website.

16. The method of unlocking a portable memory device as claimed in claim 4, including hosting the website.

17. The method of unlocking a portable memory device as claimed in claim 5, including hosting the website.

18. The method of unlocking a portable memory device as claimed in claim 2, including altering a register code in a flash controller of the usable memory space of the portable memory device to unlock the portable memory device.

19. The method of unlocking a portable memory device as claimed in claim 3, including altering a register code in a flash controller of the usable memory space of the portable memory device to unlock the portable memory device.

20. The method of unlocking a portable memory device as claimed in claim 4, including altering a register code in a flash controller of the usable memory space of the portable memory device to unlock the portable memory device.
